(19) United States
(12) Patent Application Publication
(10) Pub. No.: US 2017/0222474 A1
(43) Pub. Date: Aug. 3, 2017

(54) MOBILE CHARGING APPARATUS FOR CHARGING ELECTRONIC DEVICES

(71) Applicants: Anthony Patrick Kefalos, Flemington, NJ (US); Andrew Ryan Griffin, Zanesville, OH (US); Logan Thomas Ross, Fleming, OH (US); Brady Patrick Farrell, Liberty Township, OH (US)

(72) Inventors: Anthony Patrick Kefalos, Flemington, NJ (US); Andrew Ryan Griffin, Zanesville, OH (US); Logan Thomas Ross, Fleming, OH (US); Brady Patrick Farrell, Liberty Township, OH (US)

(21) Appl. No.: 15/009,862

(22) Filed: Jan. 29, 2016

(51) Int. Cl. H02J 7/14; H02J 7/00

(52) U.S. Cl. CPC H02J 7/1446; H02J 7/0045

(57) ABSTRACT

A mobile charging apparatus is disclosed. The mobile charging apparatus includes a direct current electrical motor coupled to at least one wheel of a mobile equipment, the direct current electrical motor configured to generate an electrical power when the wheel is in motion and a battery contained in a compartment of the mobile equipment connected to a circuit connected to the direct current electrical motor and configured to receive the electrical power. The mobile charging apparatus further includes a charging port connected to the battery in a recessed area of the compartment, the charging port configured to receive power from the battery, the recessed area configured to receive an electronic device and the charging port includes a connector for charging the electronic device.

### CLAIM OF PRIORITY

The present Application for Patent claims priority to Provisional Application No. 62/111,019 entitled “A Mobile Charging Apparatus For Charging Electronic Devices,” filed Feb. 2, 2015 and hereby expressly incorporated by reference herein.

### TECHNICAL FIELD

The present embodiments relate to electronic devices. Specifically, the present embodiments relate to mobile charging systems for electronic devices.

### BACKGROUND

Consumers carry multiple portable devices. The batteries in these devices cannot withstand the daily use without requiring some type of charge at least once per day. This results in the need for a wall outlet or a portable charging device.

Worldwide, 94% of travelers carry some kind of battery operated device. While 97% of people bring at least one device on business trips. 16% of global travelers keep a power cord with them at all times, to recharge their mobile device the moment it loses power.

Many different types of portable electronic devices are currently available including: smart phones, handheld computers, music players and cellular telephones, for example. These portable electronic devices are typically powered by rechargeable power packs, which may include rechargeable batteries, such as rechargeable lithium-ion or nickel cadmium batteries, for example. Rechargeable power packs may be re-charged from a low charge state using a charger that plugs into an electrical wall outlet and the portable electronic device.

It is not always easy or convenient for a user to find an available outlet to charge a device. Devices these days do not possess very efficient batteries, resulting in the need to be charged multiple times per day. Traveling internationally results in having to carry multiple power converters in order to safely charge/power-up a device. In particular, it is difficult to find a convenient source to power a device when traveling. Outlets are difficult to find when in an airport, bus stations or other travel destinations. Portable battery charges eventually have to be recharged. However, when traveling a suitcase with wheels have become ubiquitous. Thus, a charger devices that supplies a charge using the power produced by the wheels of a suitcase or other wheeled mobile equipment would be more convenient for users.

### SUMMARY

A mobile charging apparatus is disclosed. The mobile charging apparatus includes a direct current electrical motor coupled to at least one wheel of a mobile equipment, the direct current electrical motor configured to generate an electrical power when the wheel is in motion and a battery contained in a compartment of the mobile equipment connected to a circuit connected to the direct current electrical motor and configured to receive the electrical power. The mobile charging apparatus further includes a charging port connected to the battery in a recessed area of the compartment, the charging port configured to receive power from the battery, the recessed area configured to receive an electronic device and the charging port includes a connector for charging the electronic device.

Also disclosed is a method of charging a device. The method includes generating by at least one wheel a torque, the torque applied to a direct current electrical motor through a transfer means and receiving an electrical current into a battery from the direct current electrical motor mechanically coupled to the at least one wheel of a mobile equipment through the transfer means, the electrical current generated from the direct current electrical motor when the at least one wheel is in motion. The method further includes charging the battery contained in a compartment of the mobile equipment connected to a circuit connected to the direct current electrical motor and supplying to a charging port connected to the battery in a recessed area of the compartment, the charging port configured to receive power from the battery, the recessed area configured to receive an electronic device and the charging port includes a connector for charging the electronic device.

### DRAWINGS

The following figures set forth embodiments of the invention in which like reference numerals denote like parts. Embodiments of the invention are illustrated by way of example and not by way of limitation in the accompanying figures.

FIG. 1 is a plain view diagram of an example of a conventional suit case with wheels;

FIG. 2 is a block diagram of an exemplary charger system contained in the body of a suitcase according to present embodiments;

FIG. 3 is a block diagram of a back of an exemplary charger system integrated in a conventional suitcase with wheels;

FIG. 4 is an exemplary worm gear system for transferring the rotational torque of a wheel to the rotation of a motor to generate an electric current.

FIG. 5 is an exemplary mesh gear system for transferring the rotational torque of the free wheel to the rotation of a motor to generate an electric current.

FIG. 6 is an exemplary belt drive system for transferring the rotational torque of the wheels to the rotation of a motor to generate an electric current.

FIG. 7 is an exemplary belt drive system shown as implemented in the exemplary suitcase;

FIG. 8 is an exemplary free wheel system of the present subject matter;

FIG. 8a is an exemplary mesh gear system for the free wheel system of FIG. 8

FIG. 9 is an exemplary schematic view of a charging system according to present embodiments;

FIG. 10 is an exemplary suitcase that includes the charging system according to the present embodiments;

FIG. 11 is an exemplary flow chart of a method for charging an electronic device through the movement of a mobile system.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

The present subject matter relates to generating an electrical current from a direct current motor attached in various configurations to a wheel of mobile equipment for charging a battery in which the battery is intended for further charging an electrical device such as a phone, tablet, music player, etc. The mobile equipment may include a suitcase, backpack, portable dolly or other mobile equipment that includes wheels. The descriptions presented herein generally refer to a suitcase as the mobile equipment. The embodiments described below with respect to a suitcase are intended as examples only to simplify the description of the apparatus and methods presented herein. For example, in the embodiment of a suitcase as is presented herein, as a user walks with a wheeled suitcase in trail, the rotation of the wheels may be coupled to a motor to generate electrical power which may be used to charge a battery which is then used to charge an electronic device.

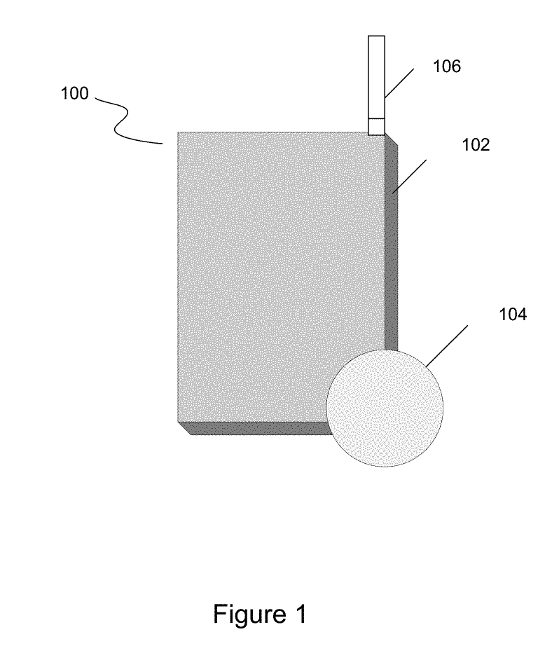

FIG. 1 is an exemplary plain view of a conventional travel suitcase 100 including a body of the suitcase 102 with two wheels 104 on each side and handle 106 across the top of the body of suitcase 102. FIG. 1 is meant as an example only to illustrate embodiments of the invention but is not intended as a limitation of the present subject matter or its implementation. The suitcase 100 could alternatively include four wheels, a roller instead of wheels or any similar suitcase that includes wheels or rollers for ease of transport by a user.

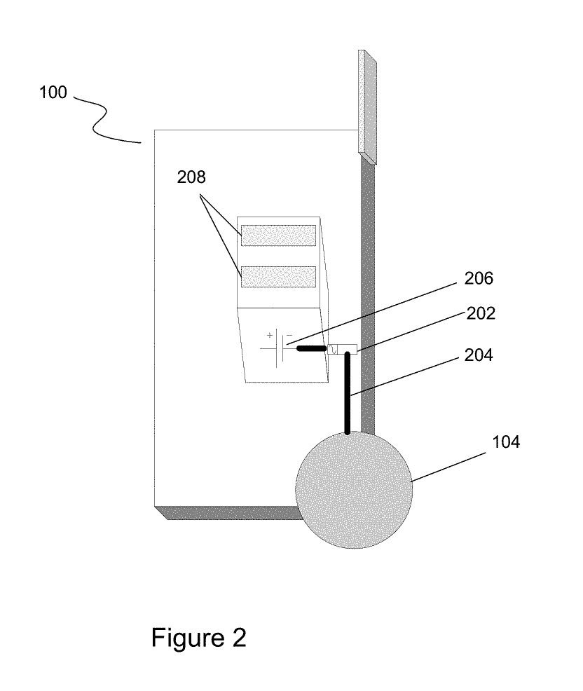

Turning now to FIG. 2, a schematic diagram of an exemplary charger system contained in the body of a suitcase 100 according to present embodiments. The charger system 206 receives electrical power from an electric motor (not shown) attached through the use of an axle means to wheels 104. The electrical power is transferred from the motor to the charger system 206 through supply lines 204. Supply lines 204 are configured to supply power to battery 206 through relay 202. Battery 206 is configured to supply power to a charging access means such as USB power output sockets 208. USB power output sockets 208 may output 5V/1.5A, for example. The batter 206 and the USB power output sockets 208 may be included within a compartment 201 along with other circuitry as needed. The charging access means is not limited to a USB output but may be any configuration required by an external electronic device.

Relay 202 may be configured as a diode bridge, for example, allowing current to flow in a positive direction into the battery 206 regardless of the direction the wheels 104 rotate. Thus, the suitcase 100 may be pushed or pulled and a charging current will still be applied to battery 206.

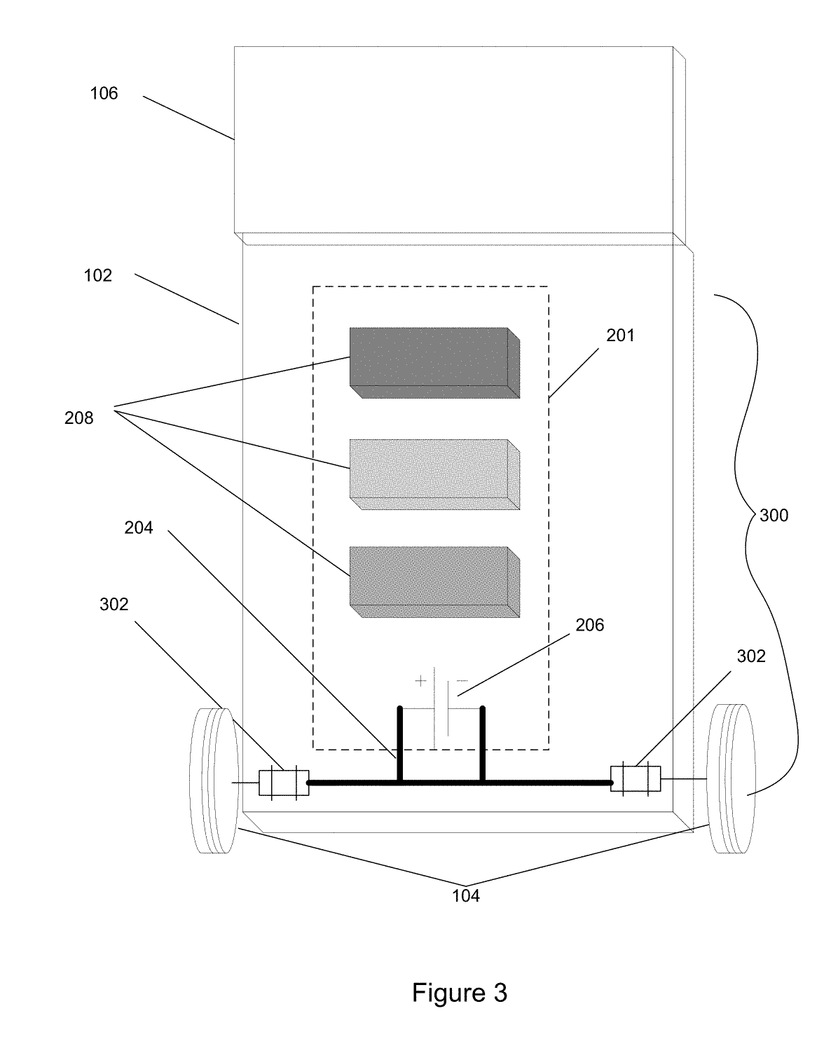

FIG. 3 is a plain view of a back of an exemplary charger system 300 integrated in a conventional suitcase 100 with wheels or rollers. In this exemplary view, two direct current (DC) electrical motors 302 are mechanically coupled to the axle of each wheel 104. Embodiments of the present subject matter may also include just one motor 302 or multiple motors 302 for each wheel. Supply lines 204 carry an electrical current produced by the DC motors 302 to the battery 206. Additional circuitry (not shown) carries the power from the battery 206 to USB ports 208. USB ports 208 are configured to supply charging power to various electronic devices such as cell phones, music players, tablet devices, cameras and other electronic devices capable of being charge by a USB power supply. Although three USB ports are shown, more or fewer USB ports may be included depending on the battery used. Alternate embodiments may include more than one battery 206 to be charged by electrical current from the DC motors 302.

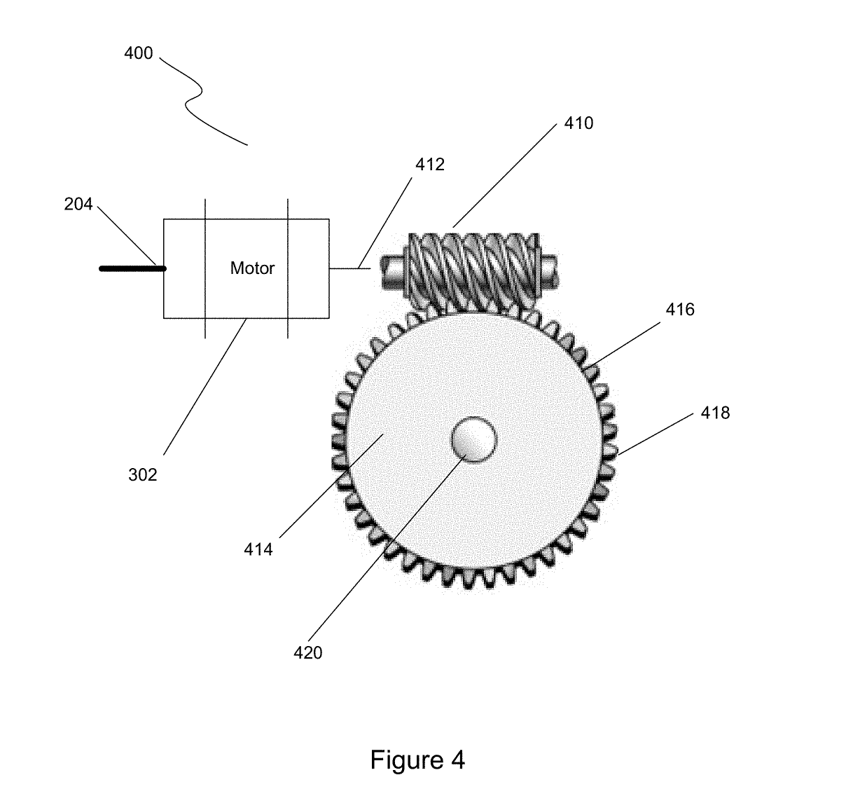

FIG. 4 is an exemplary worm gear system 400 for transferring the rotational torque of the wheels 104 to the rotation of a motor 302 to generate an electric current to the supply lines 204. A worm gear 410 is coupled to a shaft 412 of motor 302. A spur gear 414 is mounted parallel to the wheel 104 (not shown). The spur gear 414 includes an outer gear ring 416. Gear teeth 418 on the outer gear ring 416 are on the external circumference of the gear 414. Spur gear 414 is configured to mate in a mesh fashion with the worm gear 410. Spur gear 414 is centered on an axle 420 of wheel 104. As wheel 104 rotates, spur gear 414 coupled to the axle of wheel 104 causes worm gear 410 to rotate turning the shaft 412 of motor 302 and causes motor 302 to consequently generate an electrical current output to supply lines 204. In this manner, the rotational torque of wheel 104 is transferred to motor 302 to produce a current through supply lines 204 for the mobile charging system 206 (not shown) presented herein.

The shaft 412 is shown as a straight shaft but may alternatively include an elbow or may include an angled shaft. Alternatively, shaft 412 may be made of a flexible material allowing the kinetic energy of the rotating wheel 104 to be transferred to the motor 302 for any desired positioning of the motor 302 in relation to the wheels 104.

The worm gear system 400 may be mounted within the suitcase 100 as shown in FIG. 3, for example or may alternatively be located external to the suitcase 100. The worm gear system 400 may comprise, in various exemplary embodiments of the present teachings, for example, a stainless steel part with various gear ratios.

Each worm gear 410 and mating spur gear 414 in the worm gear system 400 may be of different size and of various diameters. Those of ordinary skill in the art would understand, however, that the ring gear may have various configurations (e.g., sizes, numbers of teeth, and/or pitches) and be formed from various materials including, for example, a metal such as steel, and that the configuration and material used for the worm gear system 400 may be chosen as desired based on strength, efficiency, cost, the speed and load desired to be supported and other such design factors. Furthermore, more than two gears may operate in the worm gear system 400 to allow greater speed or torque to the motor 302.

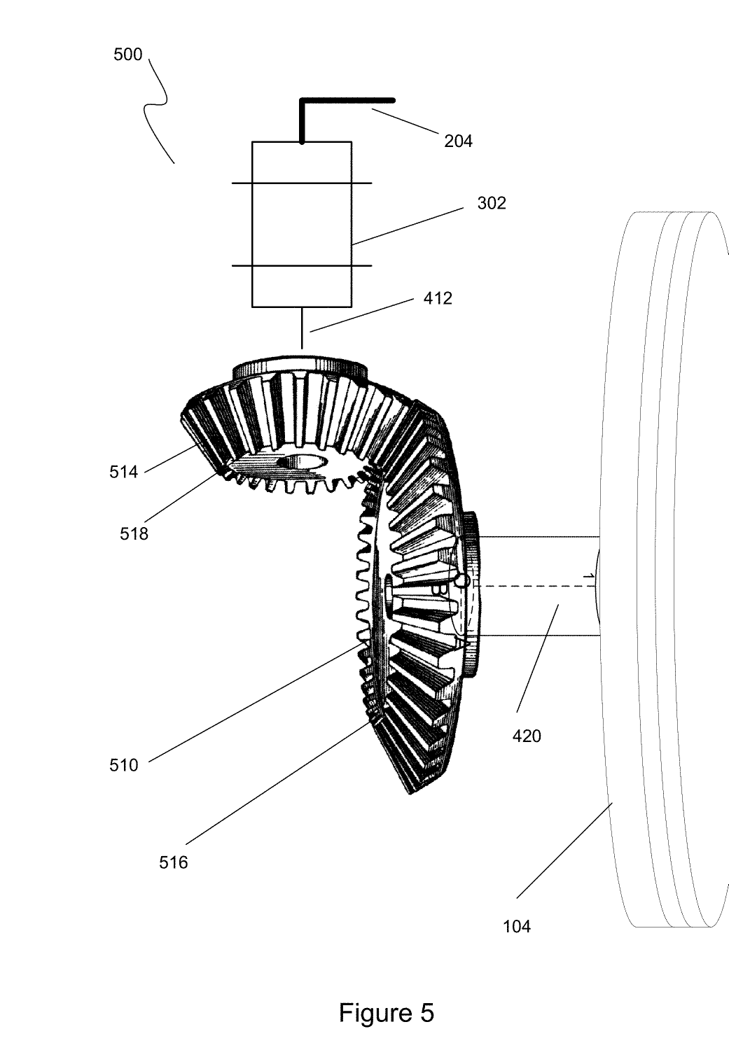

FIG. 5 is an exemplary miter gear system 500 for transferring the rotational torque of the wheels 104 to the rotation of a motor 302 to generate an electric current to supply lines 204 similar to the discussion above with respect to FIG. 4. A miter wheel gear 510 is coupled to an axle 420 of the wheel 104 in which the wheel gear 510 is parallel to the wheel 104. Miter wheel gear 510 includes an outer gear ring with teeth 516 on the external circumference of the wheel gear 510. A mating miter motor gear 514 is coupled to the shaft 412 of motor 302 and is configured to mate in a mesh fashion with the miter gear 510. The teeth 518 of mating miter gear 514 mesh with the miter gear teeth 516 on the miter wheel gear 510. Mating miter gear 514 is centered on an axle 420 of wheel 104. As wheel 104 rotates, mating miter gear 514 attached to the axle of wheel 104 causes miter wheel gear 510 to rotate turning the shaft 412 of motor 302 and causes motor 302 to consequently generate an electrical current through the supply lines 204. In this manner, the rotational torque of wheel 104 is transferred to motor 302 to produce an output current to supply lines 204 for the mobile charging system presented herein.

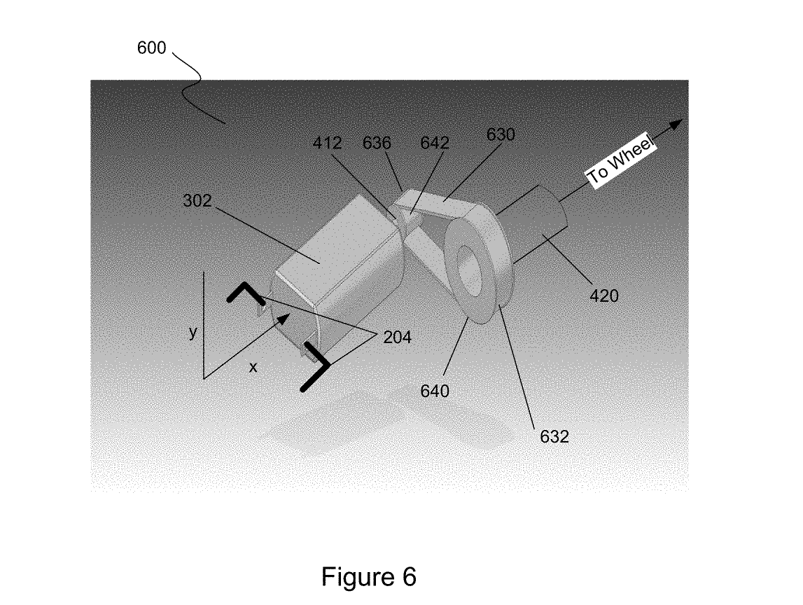

FIG. 6 is an exemplary belt drive system 600 for transferring the torque of the wheels 104 (not shown) to the rotation of a motor 302 to generate an electric current. A belt 630 is located on a first end 632 of a pulley wheel 640 coupled to the axle means 420 of wheel 104, and on a second end 636 of a smaller pulley wheel 642 coupled to motor 302 in a belt-pulley type system. Thus, as wheel 104 rotates, belt 630 causes the kinetic energy of the rotating wheel 104 to be transferred to motor 302. Belt 630 is mounted under tension to reduce slippage on belt drive system 600 and capable of being set in rotation around the X axis of motor 302. In this manner, the belt drive system 600 transfers the rotational torque of wheel 104 to motor 302 to produce a current output to supply lines 204 for the mobile charging system presented herein.

Table 1 below presents various gear ratios associated with the belt drive system 600 that may be used in the exemplary suitcase 100. Table 1 lists various diameters of wheel 104 and gear ratios to result in the exemplary rotational speeds in RPMs generated. Table 1 is presented as an aid in understanding the embodiments of the present subject matter and not intended as limiting the embodiments presented herein.

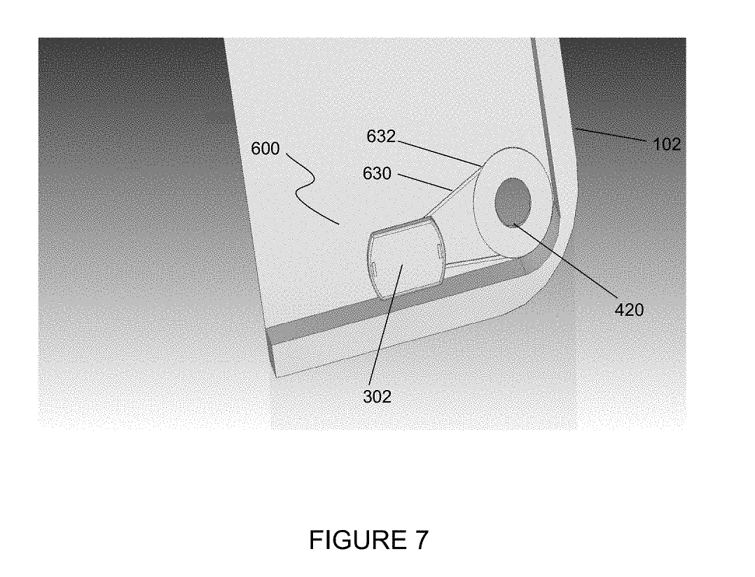

FIG. 7 is an exemplary belt drive system 600 shown as implemented in the exemplary suitcase 100 described herein. FIG. 7 shows one example of how the belt drive system 600 may be embedded inside suitcase 100. Belt 630 is attached to axle means 420 at first end 632 to rotate drive shaft means 412 (not shown) to enable motor 302 to generate an output current for the charging system 300 (not shown). The configuration and location of the belt drive system 600 within a mobile equipment and the location of each pulley 640 and 642 may vary to accommodate the type of equipment, availability of space and other factors and is not intended to be limited to the configuration and locations shown.

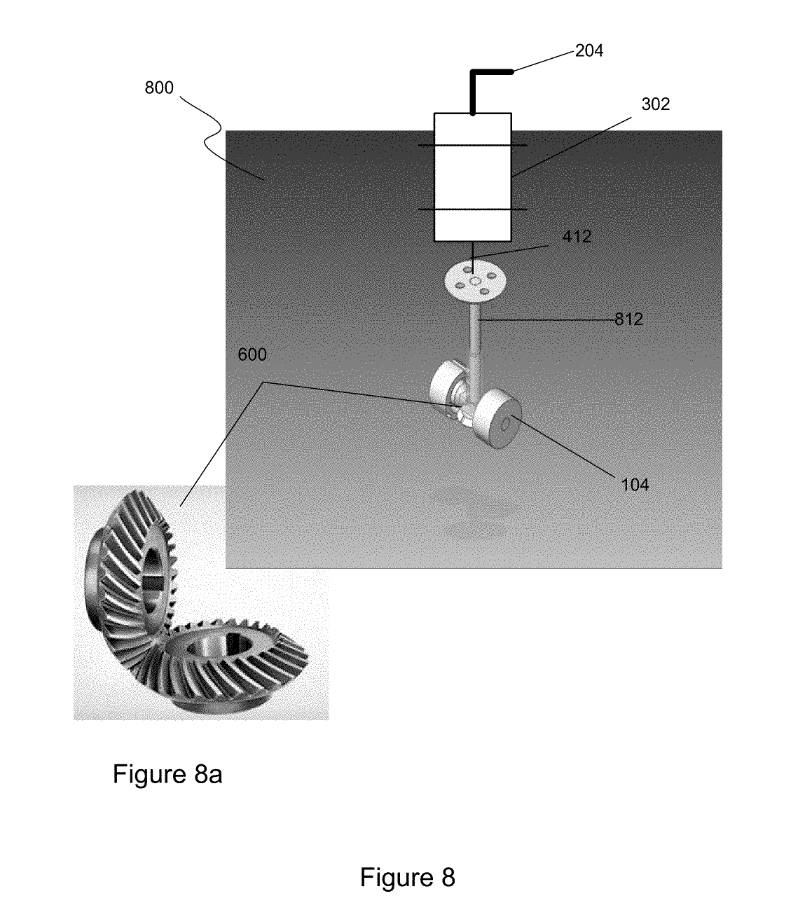

FIG. 8 is an exemplary free wheel system 800 for transferring the torque of the free rotating wheels 104 to the rotation of a motor 302 to generate an electric current output to supply lines 204. In a free wheel system 800, the wheels 104 are allowed to independently rotate to allow easier maneuverability of a suitcase 100 or other mobile equipment. A miter gear system 500 such as that described above with respect to FIG. 5 may be employed. The miter gear system 500 is coupled to each wheel 104 with the mating miter gears as shown in FIG. 8a enabled to rotate a shaft 812. The shaft 812 is attached to motor 302 through shaft 412, for example, thus the meshed gears of the miter gear system 500 transfers the rotational torque of wheels 104 to motor 302. The shaft 812 is shown as a straight shaft but may alternatively include an elbow; may include an angled shaft; or be made of a flexible material allowing the kinetic energy of the rotating wheel 104 to be transferred to the motor 302

Alternatively, a worm gear system 400 may be used in a free wheel system 800 in a similar manner.

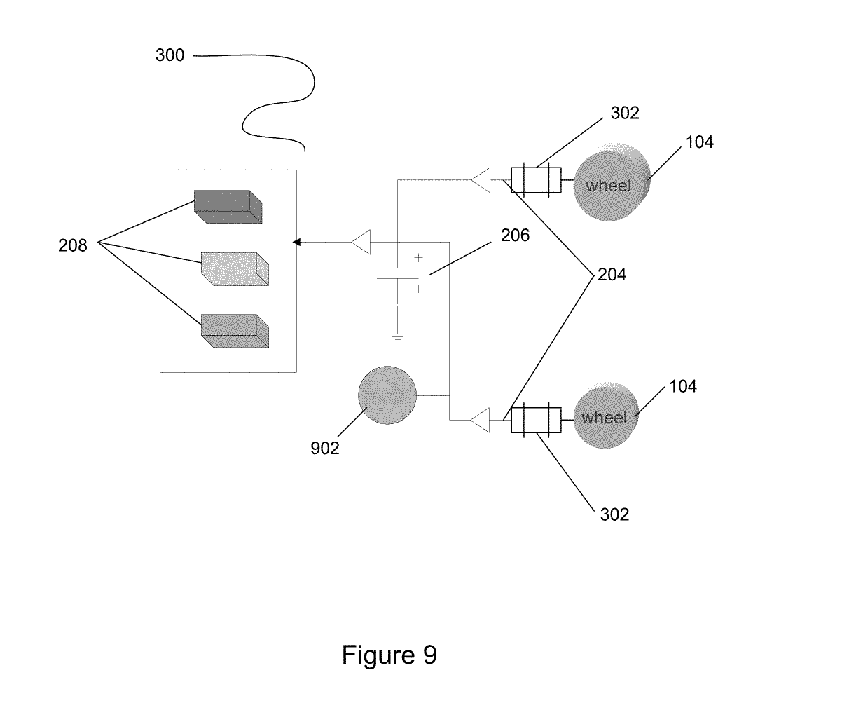

FIG. 9 is an exemplary schematic view of a charging system 300 according to present embodiments. The DC motors 302 are mechanically coupled to the axles of wheels 104. As in the normal operation of an electric motor, the interaction between the magnetic field of electric motor 302 generated within the DC motor 302 by the movement of wheels 104 to produce a current in the windings (not shown) of the motors 302 to generate a current that flows to battery 206 through supply lines 204. In this manner, battery 206 receives a charging current from the motors 302 to enable battery 206 to be charged to a rated capacity of the battery 206. Battery 206 is configured to supply power to a output sockets to charge external electronic devices such as USB ports 208 to charge any compatible electronic device plugged into the USB ports 208. Battery 206 does not have to be fully charged to capacity to enable power to the USB ports 208 for charging.

Also included in the schematic view of FIG. 9 is a power input socket 902 which can alternatively be used to charge battery 206 from an alternate power source. Such power source may include a solar panel, power from an electrical outlet, and the like.

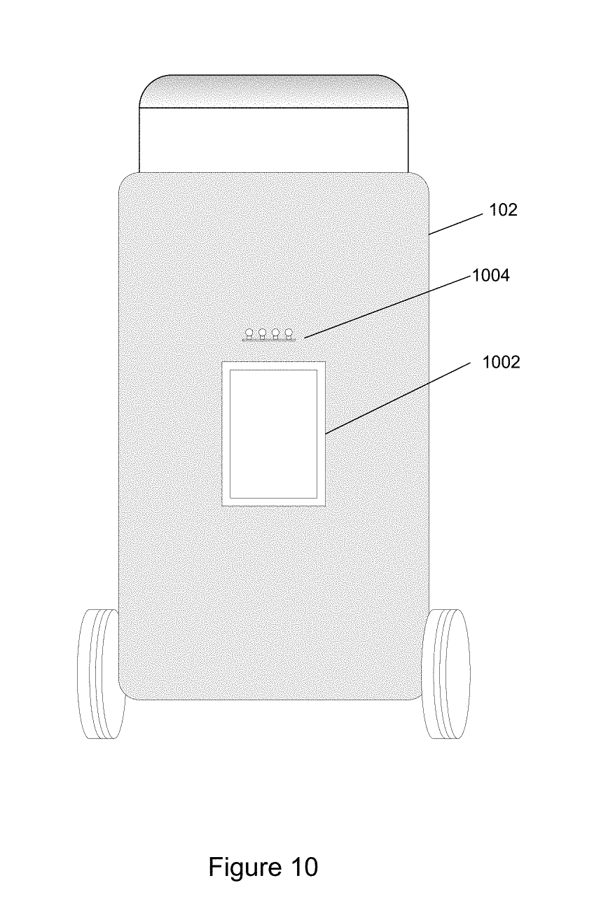

FIG. 10 is an exemplary suitcase that includes the charging system according to the present embodiments. Suitcase body 102 may include a compartment 1002 that contains charger system 300 and adequate space to house various electronic devices to store for charging and easy retrieval. A display 1004 may also be included inside compartment 1002 or alternatively outside indicating battery and charge levels.

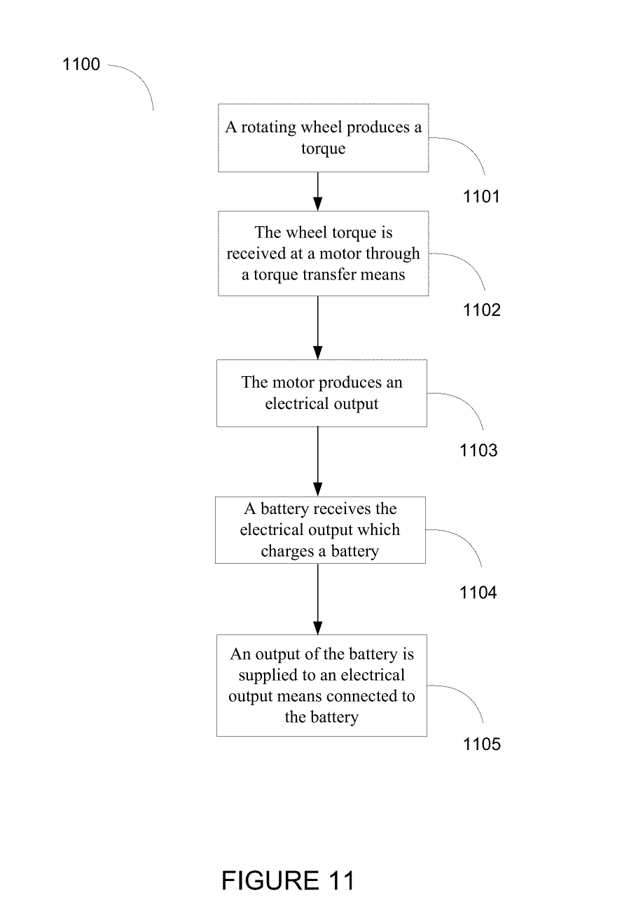

FIG. 11 is an exemplary flow chart of a method for charging an electronic device through the movement of a mobile system. The method starts at step 1101 when a rotating wheel 104 produces a torque. The energy of the wheel torque is received at step 1102 at a motor 302 through an torque transfer means such as gear mesh or belt system (See FIG. 4-8). The motor 302 produces an electrical output at step 1103. A battery 206 receives the electrical output at step 1104 which charges battery 206. An output of battery 206 is then supplied to an electrical output means connected to the battery which may, for example, reside in a recessed area of a compartment 1002 in suitcase body 102 at step 1105. The electrical output means may be a USB interface 208, for example. An electronic device may then be plugged into the electrical output means in order to charge the electronic device.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

We claim:

1. A mobile charging apparatus comprising:
a direct current electrical motor coupled to at least one wheel of a mobile equipment, the direct current electrical motor configured to generate an electrical power when the wheel is in motion;
a battery contained in a compartment of the mobile equipment connected to a circuit connected to the direct current electrical motor and configured to receive the electrical power; and
a charging port connected to the battery in a recessed area of the compartment, the charging port configured to receive power from the battery, the recessed area configured to receive an electronic device and the charging port includes a connector for charging the electronic device.

2. The mobile charging device of claim 1, wherein the connector is a Universal Serial Bus (USB) connector.

3. The mobile charging device of claim 1, wherein the mobile equipment includes a suitcase, a backpack or a trunk.

4. The mobile charging device of claim 1, wherein the wheel the at least one wheel is in a fixed position.

5. The mobile charging device of claim 1, wherein the at least one wheel rotates to adjust to a direction.

6. The mobile charging device of claim 5, wherein the electrical motor is coupled to the at least one wheel through a multidirectional shaft that transfers the rotation of the wheels to cause a rotation of the direct current electrical motor.

7. The mobile charging device of claim 1, wherein the circuit connecting the direct current electrical motor to the battery includes a relay circuit that allows a current to flow to the battery from the direct current electrical motor regardless of a direction the at least one wheel rotates.

8. The mobile charging device of claim 1, wherein the direct current electrical motor is coupled to the at least one wheel through a mesh gear system.

9. The mobile charging device of claim 1, wherein the direct current electrical motor is coupled to the at least one wheel through a belt drive system.

10. A method of charging a device, the method comprises:
generating by at least one wheel a torque, the torque applied to a direct current electrical motor through a transfer means;
receiving an electrical current into a battery from the direct current electrical motor mechanically coupled to the at least one wheel of a mobile equipment through the transfer means, the electrical current generated from the direct current electrical motor when the at least one wheel is in motion;
charging the battery contained in a compartment of the mobile equipment connected to a circuit connected to the direct current electrical motor; and
supplying an electrical output to a charging port connected to the battery in a recessed area of the compartment, the charging port configured to receive power from the battery, the recessed area configured to receive an electronic device and the charging port includes a connector for charging the electronic device.

11. The method of claim 10, wherein the connector is a Universal Serial Bus (USB) connector.

12. The method of claim 10, wherein the mobile equipment includes a suitcase, a backpack or a trunk.

13. The method of claim 10, wherein the at least one wheel is in a fixed position.

14. The method of claim 10, wherein the at least one wheel rotates to adjust to a direction.

15. The method of claim 14, wherein the electrical motor is attached to the at least one wheel through a multidirectional shaft that transfers the rotation of the wheels to cause a rotation of the electrical motor.

16. The method of claim 10, wherein the circuit connecting the direct current electrical motor to the battery includes a relay circuit that allows a current to flow to the battery from the motor regardless of a direction the at least one wheel rotates.

17. The method of claim 10, wherein the transfer means is a mesh gear system.

18. The method of claim 10, wherein the transfer means is a belt system.
